(19) United States
(12) Patent Application Publication
(10) Pub. No.: US 2024/0202496 A1
(43) Pub. Date: Jun. 20, 2024

(54) NEURAL NETWORK STRUCTURE SEARCH DEVICE AND NEURAL NETWORK STRUCTURE SEARCH METHOD

(71) Applicant: NEC Corporation, Minato-ku, Tokyo (JP)

(72) Inventor: Yuki KOBAYASHI, Tokyo (JP)

(73) Assignee: NEC Corporation, Minato-ku, Tokyo (JP)

(21) Appl. No.: 18/286,304

(22) PCT Filed: Apr. 20, 2021
(86) PCT No.: PCT/JP2021/015964

§ 371 Date: Oct. 10, 2023

(51) Int. Cl. G06N 3/045; G06N 3/0895

(52) U.S. Cl. CPC G06N 3/045; G06N 3/0895

(57) ABSTRACT

A neural network structure search device includes a training unit which trains a neural network model with a first neural network structure using a data set for training, a first generation unit which generates analysis information indicating an importance of each of elements comprising the first neural network structure by analyzing a trained model generated from the neural network model by the training using the data set for training, an identifying unit which identifies an element in the first neural network structure whose importance is lower than a predetermined value using the generated analysis information, and a second generation unit which generates a second neural network structure based on the first neural network structure by deleting the identified element from the first neural network structure.

### TECHNICAL FIELD

The present invention relates to a neural network structure search device, a neural network structure search method, and a neural network structure search program. In particular, the present invention relates to a neural network structure search device, a neural network structure search method, and a neural network structure search program that derive an optimal neural network structure in a short time by reducing the number of training times required for the search.

### BACKGROUND ART

A neural network structure is a typical mathematical model structure used in the field of deep learning. The neural network structure includes the number of layers, the number of channels in each layer, kernel size, etc.

In addition, to find the optimal neural network structure, it is necessary to a work of searching for a neural network structure that recognition processing can be performed at high speed while maintaining high recognition accuracy. This work was often performed by researchers and engineers familiar with AI (Artificial Intelligence), for example, on an individual basis based on their own experience.

In contrast to the work of searching the neural network structure manually described above, several methods of searching the neural network structure automatically, NAS (Neural Architecture Search), have been proposed.

For example, Non Patent Literature (NPL) 1 describes a technique for finding a neural network structure with higher recognition accuracy than a human-designed neural network structure because of reinforcement learning.

NPL 2 describes a technique that can perform searching without reinforcement learning by continuously relaxing the search problem to make it differentiable.

NPL 3 describes a technique for deriving a neural network structure in which recognition processing is performed at high speed and recognition accuracy is high by building up and combining parts of the neural network structure with relatively good recognition processing efficiency in a bottom-up manner.

NPL 4 describes M2Det, an example of a neural network structure.

### CITATION LIST

### Non Patent Literature

NPL 1: Barret Zoph and Quoc V. Le, “Neural Architecture Search with Reinforcement Learning,” Under review as a conference paper at ICLR 2017.
NPL 2: Hanxiao Liu, Karen Simonyan, and Yiming Yang, “DARTS: Differentiable Architecture Search,” Published as a conference paper at ICLR 2019.
NPL 3: X. Zhang, et al., “SkyNet: A hardware-efficient method for object detection and tracking on embedded systems,” in Proc. Conf. Mach. Learn. Syst., 2020, pp. 216-229.
NPL 4: Q. Zhao, et al., “M2Det: A Single-Shot Object Detector Based on Multi-Level Feature Pyramid Network,” pp. 9259-9266, Vol. 33 No. 01: AAAI-19.

### SUMMARY OF INVENTION

### Technical Problem

In neural network structure search, there are a vast number of neural network structures to be searched. In addition, in order to evaluate the accuracy of the neural network structure, it is required to repeatedly perform “Training (synonymous with Learning),” which requires time during the search.

The reason for this is that even if only a neural network structure is devised, the recognition accuracy of the devised neural network structure is unknown. This is because in order to confirm the recognition accuracy, it is required to determine the weights of the devised neural network structure using a data set for training.

In general, the recognition accuracy of a neural network structure does not necessarily improve as the number of layers or channels is increased, nor does it necessarily decrease as the number of layers or channels is decreased. It will not be known what kind of structure will improve recognition accuracy until training is performed in which weights are progressively updated while repeating forward and backward propagation.

For example, hours to days are required for a single training to be completed. In addition, the training is required to be performed dozens of times repeatedly during the search. In other words, in searching of the neural network structure, the problems are that abundant computer resources are required and that a search period is lengthened.

Even with the technique described in NPL 1, the problem is that the computational cost required for the search is enormous, for example, 800 GPUs (Graphics Processing Units) must be operated for a long period of time.

The techniques described in NPLs 2-3 also require that the training be performed more than a few times repeatedly, making it difficult to complete the search in a short time.

Furthermore, methods of searching neural network structure for published high-precision neural network structures, such as the neural network structure described in NPL 4, are not disclosed.

In other words, methods of efficiently deriving a neural network structure where the performing speed of the recognition processing is up by optimizing the neural network structure while maintaining the recognition accuracy required by applications that use the neural network structure, are not disclosed.

Therefore, it is an object of the present invention to provide a neural network structure search device, a neural network structure search method, and a neural network structure search program that can reduce the number of training times required for searching a neural network structure.

### Solution to Problem

A neural network structure search device according to the present invention is a neural network structure search device includes a training means which trains a neural network model with a first neural network structure using a data set for training, a first generation means which generates analysis information indicating an importance of each of elements comprising the first neural network structure by analyzing a trained model generated from the neural network model by the training using the data set for training, an identifying means which identifies an element in the first neural network structure whose importance is lower than a predetermined value using the generated analysis information, and a second generation means which generates a second neural network structure based on the first neural network structure by deleting the identified element from the first neural network structure.

A neural network structure search method according to the present invention is a neural network structure search method includes training a neural network model with a first neural network structure using a data set for training, generating analysis information indicating an importance of each of elements comprising the first neural network structure by analyzing a trained model generated from the neural network model by the training using the data set for training, identifying an element in the first neural network structure whose importance is lower than a predetermined value using the generated analysis information, and generating a second neural network structure based on the first neural network structure by deleting the identified element from the first neural network structure.

A neural network structure search program according to the present invention is a neural network structure search program causing a computer to execute a training process of training a neural network model with a first neural network structure using a data set for training, a first generation process of generating analysis information indicating an importance of each of elements comprising the first neural network structure by analyzing a trained model generated from the neural network model by the training using the data set for training, an identifying process of identifying an element in the first neural network structure whose importance is lower than a predetermined value using the generated analysis information, and a second generation process of generating a second neural network structure based on the first neural network structure by deleting the identified element from the first neural network structure.

### Advantageous Effects of Invention

According to the present invention, it is possible to reduce the number of training times required for searching a neural network structure.

### BRIEF DESCRIPTION OF DRAWING

FIG. 1 is a block diagram showing an example of the configuration of a neural network structure search device of the example embodiment of the present invention.

FIG. 2 is an explanatory diagram showing an example of a convolutional neural network.

FIG. 3 is an explanatory diagram showing an example of convolution computation in the CNN.

FIG. 4 is an explanatory diagram showing an example of model analysis information.

FIG. 5 is an explanatory diagram showing another example of model analysis information.

FIG. 6 is a flowchart showing an operation of the neural network structure searching process by the neural network structure search device 100 of the present example embodiment.

FIG. 7 is a flowchart showing another operation of the neural network structure searching process by the neural network structure search device 100 of the present example embodiment.

FIG. 8 is an explanatory diagram showing an example of a hardware configuration of a neural network structure search device according to the present invention.

FIG. 9 is a block diagram showing an overview of a neural network structure search device according to the present invention.

### DESCRIPTION OF EMBODIMENTS

The following is a description, with reference to the drawings, of an example embodiment of the present invention. The neural network structure search device of the present invention is a device that can solve the problem that a large number of trainings to search for neural network structures is required.

Specifically, the neural network structure search device of the present invention first performs training on the entire neural network model with the neural network structure based on the given training data set. The training data set is a training data set used for training. The training data set is pre-labeled with a label indicating the correct answer.

From the trained model, which is a trained neural network model, information such as the weights of the neural network structure, which are the training results, is obtained. Next, the neural network structure search device analyzes the training results and determines a new neural network structure so that the size is reduced while the recognition accuracy is maintained.

### DESCRIPTION OF CONFIGURATION

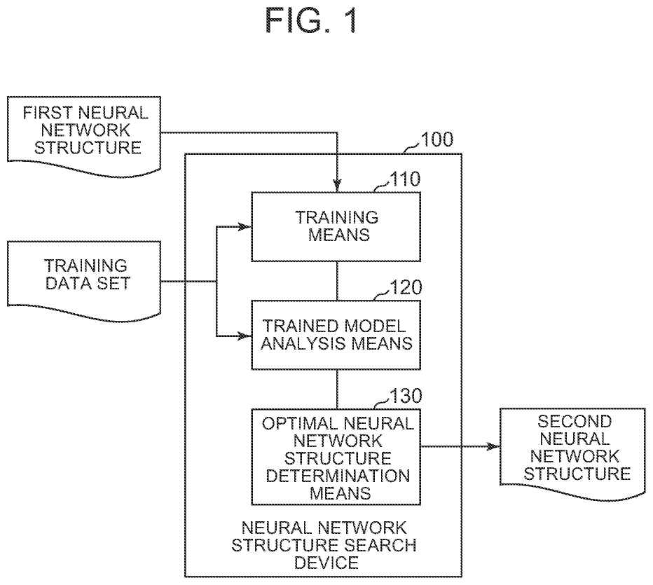

FIG. 1 is a block diagram showing an example of the configuration of a neural network structure search device of the example embodiment of the present invention.

As shown in FIG. 1, the neural network structure search device 100 of this example embodiment includes a training means 110, a trained model analysis means 120, and an optimal neural network structure determination means 130. Each of the means operates as follows.

The training means 110 receives as input the first neural network structure and the training data set. The training means 110 then generates a neural network model with the first neural network structure. The training means 110 performs training in deep learning using the training data set on the generated neural network model. The training means 110 inputs the trained model, which is the result of the training, to the trained model analysis means 120.

The first neural network structure input to the training means 110 is, for example, a neural network structure that has already been published and has high recognition accuracy.

The first neural network structure envisioned in this example embodiment is, for example, a convolutional neural network (CNN) structure. A convolutional neural network is a feed-forward neural network with a structure consisting of two alternately stacked layers, a convolutional layer and a pooling layer. Hereafter, the convolutional neural network is also referred to simply as the CNN.

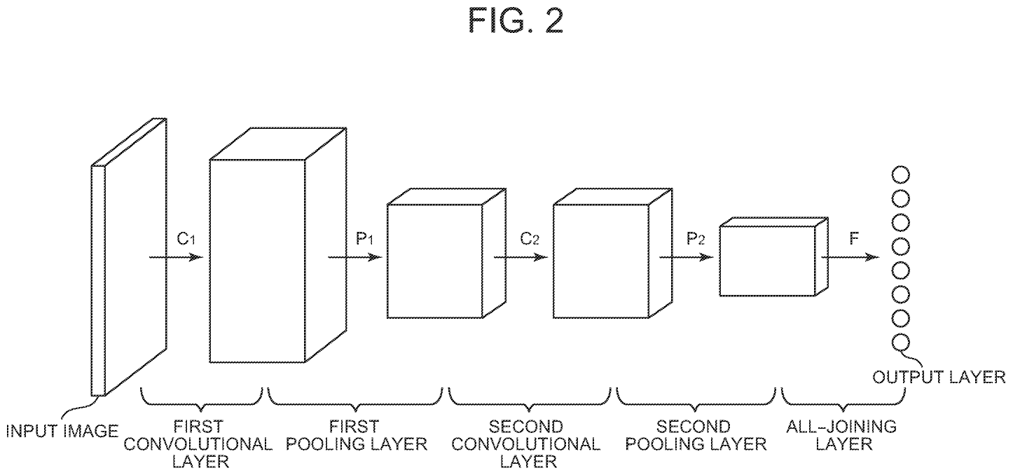

FIG. 2 is an explanatory diagram showing an example of a convolutional neural network. In the CNN shown in FIG. 2, the first convolutional layer, the first pooling layer, the second convolutional layer, and the second pooling layer are stacked alternately.

C₁ and C₂ shown in FIG. 2 represent convolution computations, respectively. For example, the convolution computation C₁ is performed on the input image that is input to the first convolution layer.

Note that images are an example of input data. The data input to the CNN may be data other than images.

P₁ and P₂ shown in FIG. 2 represent pooling computations, respectively. For example, the pooling computation P₁ is performed on the result of the convolution computation that is input to the first pooling layer.

F shown in FIG. 2 represents the all-joining network. The all-joining network F has the function of an all-joining layer that joins all the nodes of the second pooling layer with those of the output layer. Finally, the output of the CNN is obtained from the output layer.

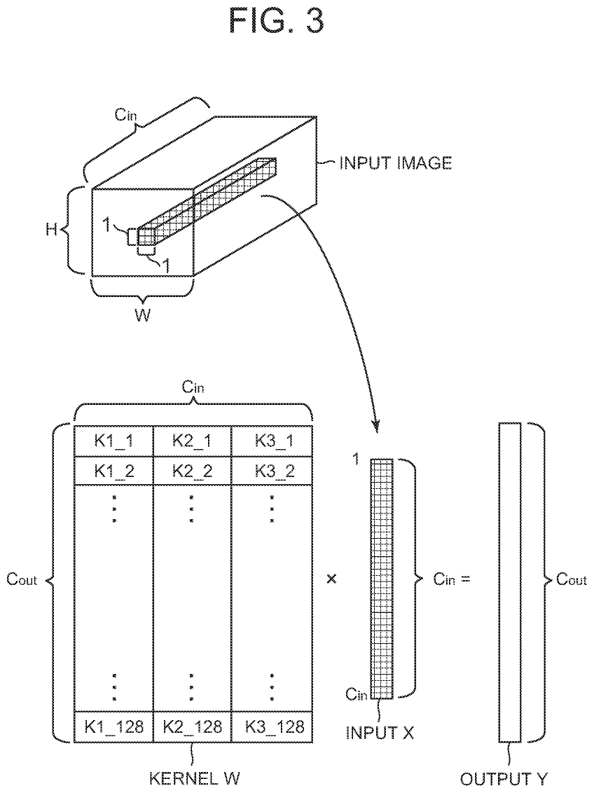

The following is a specific explanation of the convolution computation in a CNN. FIG. 3 is an explanatory diagram showing an example of convolution computation in the CNN. The example of convolution computation shown in FIG. 3 corresponds to the convolution computation C₁ shown in FIG. 2.

The input image shown in FIG. 3 is the image that is input to the CNN. The input image shown in FIG. 3 consists of the first to Cᵢₙ channels (Cᵢₙ is an integer greater than or equal to 2) in sequence. In other words, Cᵢₙ means the number of input channels. As shown in FIG. 3, the vertical size and the horizontal size of the image comprising the input image are H and W.

For simplicity of explanation, consider as input X, the object of the convolution computation, an image with a vertical size of 1, a horizontal size of 1, and a number of channels Cᵢₙ marked with the grid pattern shown in FIG. 3. The bottom row of FIG. 3 shows the input X as viewed from the height direction. The sign to the left of input X shown in FIG. 3 is the identification number of the channel.

In the convolution computation shown in FIG. 3, the input X is multiplied with the 1×1 kernel W whose vertical size is Cₒᵤₜ and whose horizontal size is Cᵢₙ. As a result of the multiplication, the output Y, which is an image with the number of channels Cₒᵤₜ, is obtained. In other words, Cₒᵤₜ means the number of output channels. In the example shown in FIG. 3, Cᵢₙ=3 and Cₒᵤₜ=128.

The convolution computation shown in FIG. 3 corresponds to the multiplication of matrices by each other. That is, in the convolution computation shown in FIG. 3, the kernel W, input X, and output Y are each treated as a matrix.

In addition to the CNN structure, it is assumed in this example embodiment that a neural network structure with a large number of layers and considered to have high recognition accuracy may be input to the training means 110 as the first neural network structure. However, a neural network structure other than the above may be input to the training means 110 of this example embodiment as the first neural network structure.

As described above, the training means 110 trains the neural network model with the first neural network structure using the data set for training.

The trained model analysis means 120 analyzes the trained model input from the training means 110 using the training data set. By analyzing, the trained model analysis means 120 inputs model analysis information indicating redundant portions in the first neural network structure to the optimal neural network structure determination means 130.

There are several possible analysis methods used by the trained model analysis means 120. The first is a method that sequentially inputs data (e.g., images) in the training data set to the trained model and observes the activation rate of each part (e.g., each channel of each layer) in the first neural network structure.

Using the first analysis method, the trained model analysis means 120 can identify the parts of the first neural network structure that are less activated than the other parts. The trained model analysis means 120 can obtain the activation rate using a statistical measure such as the average of the values of the activation map.

The second is a method that identify kernels that include many weights near zero by analyzing trained models when the first neural network structure is a CNN structure. The kernels that include many weights near zero are considered to have no significant effect on the processing results by the first neural network structure even if they are deleted.

By analyzing using the above analysis method etc., the trained model analysis means 120 can identify portions of the first neural network structure that have a relatively low contribution to the final result, i.e., redundant portions.

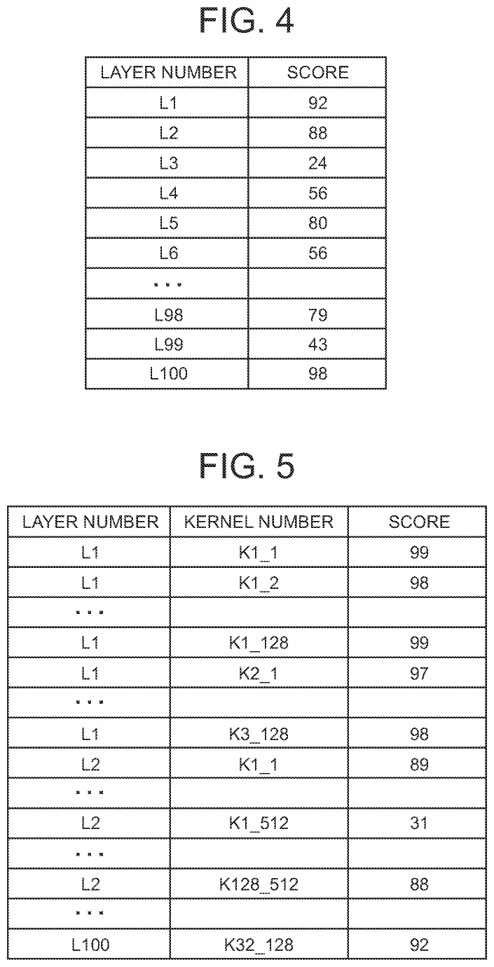

FIG. 4 is an explanatory diagram showing an example of model analysis information. The model analysis information shown in FIG. 4 consists of layer numbers and scores. In other words, FIG. 4 shows the score for each layer.

FIG. 5 is an explanatory diagram showing another example of model analysis information. The model analysis information shown in FIG. 5 consists of layer number, kernel number, and score. In other words, FIG. 5 shows the score for each kernel weight. In the examples shown in FIGS. 4-5, a CNN structure consisting of 100 layers in total is assumed as the first neural network structure.

In the example shown in FIG. 5, a layer with layer number L1 is assumed to correspond to 3 input channels and 128 output channels. In other words, the example shown in FIG. 5 corresponds to the example shown in FIG. 3. The kernel numbers shown in FIG. 3 correspond to the kernel numbers shown in FIG. 5.

As shown in FIGS. 3 and 5, the kernel used in the layer with layer number L1 consists of 3×128=384 weights. In the model analysis information shown in FIG. 5, a score is given for each weight of the kernel.

The score of this example embodiment is a value that represents the importance of weight of the layer or kernel. A score of “100” represents the highest importance, and a score of “0” represents the lowest importance.

In the example shown in FIG. 4, for example, the score for a layer with layer number L3 is “24”, which is relatively lower than the scores for the other layers. The score for a layer with layer number L99 is also “43”, which is relatively lower than the scores for the other layers.

In the example shown in FIG. 5, for example, the score for a weight of a kernel with kernel number K1_512 in a layer with layer number L2 is “31”, which is relatively lower than the scores for weights of other kernels.

For example, if the average of the values of the activation map, which is the output result of the convolution layer, is used in determining the score, it is conceivable that the trained model analysis means 120 would evaluate the average after normalizing it across channels for the activation maps of all channels obtained from any convolution layer. The trained model analysis means 120 may determine the score using the maximum value in the activation map instead of the average, or set a threshold value, determine whether the maximum value is above the threshold value, and determine the score.

The method for determining the score is not limited to the methods described above. The trained model analysis means 120 may use general statistical analysis methods to determine the score.

In other words, the trained model analysis means 120 analyzes the trained model generated from the neural network model by the training of the training means 110 using the data set for training. By analyzing, the trained model analysis means 120 generates analysis information indicating the importance of each of the elements comprising the first neural network structure.

As mentioned above, each element may include a layer that constitutes the first neural network structure.

Also, each element may include weights in the kernel used in the convolution layer that constitutes the first neural network structure.

Also, as mentioned above, the trained model analysis means 120 computes importance based on the activation rate obtained, for example, by inputting data in the data set for training into the trained model.

The optimal neural network structure determination means 130 determines and outputs the optimal neural network structure based on the model analysis information output by the trained model analysis means 120.

For example, the optimal neural network structure determination means 130 deletes the layer with layer number L3, and the layer with layer number L99, whose score are small, from the first neural network structure based on the model analysis information shown in FIG. 4. The optimal neural network structure determination means 130 outputs the first neural network structure with the layers deleted as the second neural network structure.

In order to prevent too many layers from being deleted, a threshold value, which is an upper limit on the percentage or number of layers to be deleted, may be set. For example, the optimal neural network structure determination means 130 may use a percentage, such as 50% of the total number of layers, or a number, such as 10, as the threshold value for the layers to be deleted. The threshold value of the layers to be deleted may be given to the optimal neural network structure determination means 130 from outside as an input.

If the processing time in each layer of the first neural network structure is given as input, the optimal neural network structure determination means 130 may remove the layers with longer processing times and smaller scores in priority.

If the execution efficiency of the arithmetic unit in each layer of the first neural network structure is given as an input, the optimal neural network structure determination means 130 may remove the layers with low execution efficiency and smaller scores in priority.

In general, hardware often increases parallelism by arranging many arithmetic units in a row to obtain high performance. For example, if 256 arithmetic units are arrayed side by side and the hardware only utilizes parallelism in the direction of the number of channels in those arithmetic units, only 32 arithmetic units at most can be used for a layer with a maximum number of 32 channels.

Thus, the execution efficiency of the arithmetic unit in the layer with the maximum number of channels being 32 is 32/256=⅛=12.5%. The optimal neural network structure determination means 130 may preferentially delete layers with low execution efficiency computed as above.

If a target accuracy is given as input, the optimal neural network structure determination means 130 may determine the threshold value of the score by multiplying the given target accuracy by a constant, for example. The optimal neural network structure determination means 130 removes layers whose scores are lower than the determined threshold value of the score.

As when deleting layers, the optimal neural network structure determination means 130 can also determine which kernel to be deleted based on the score when deleting kernels.

The optimal neural network structure determination means 130, for example, deletes kernels that include a predetermined percentage or more of weights with a score lower than the determined threshold value of the score. Note that when a kernel is deleted, the convolution computation that was performed using the corresponding kernel is no longer performed.

The optimal neural network structure determination means 130 may delete both layers and kernels, only layers, or only kernels.

In other words, the optimal neural network structure determination means 130 uses the analysis information generated by the trained model analysis means 120 to identify an element in the first neural network structure whose importance is lower than a predetermined value.

The optimal neural network structure determination means 130 then generates a second neural network structure based on the first neural network structure by deleting the identified element from the first neural network structure.

The optimal neural network structure determination means 130 may also determine an element to be deleted among the identified elements using the processing time of the arithmetic unit in the layer. The optimal neural network structure determination means 130 may also determine an element to be deleted among the identified elements using the execution efficiency of the arithmetic unit in the layer.

If each element includes weights in kernels, the optimal neural network structure determination means 130 may remove the kernel that includes more than a predetermined percentage of the identified weights.

As described above, the neural network structure search device 100 of this example embodiment optimizes the structure while maintaining the recognition accuracy required for the application to be applied to the published high-precision neural network structure, thereby efficiently determining the neural network structure where the recognition processing is performed at high speed.

The neural network structure search device 100 of this example embodiment does not find a neural network structure with high accuracy as in the techniques described in NPL 1, but maintains accuracy to the same degree as published models. The neural network structure search device 100 determines a neural network structure with a reduced scale so that the performance speed of the recognition processing is faster while maintaining accuracy.

### DESCRIPTION OF OPERATION

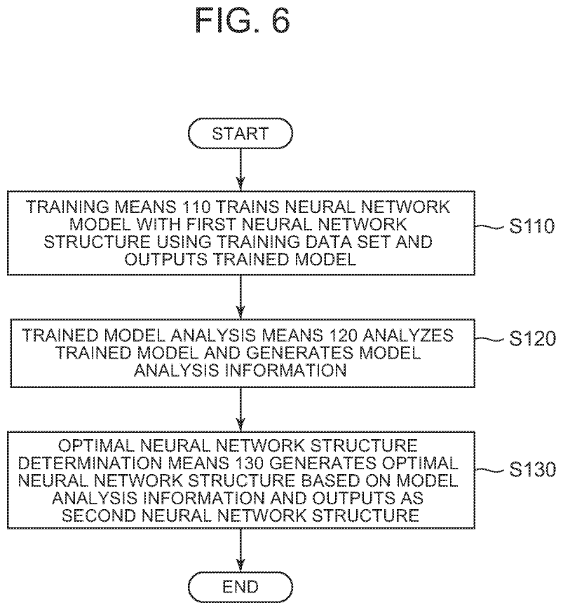

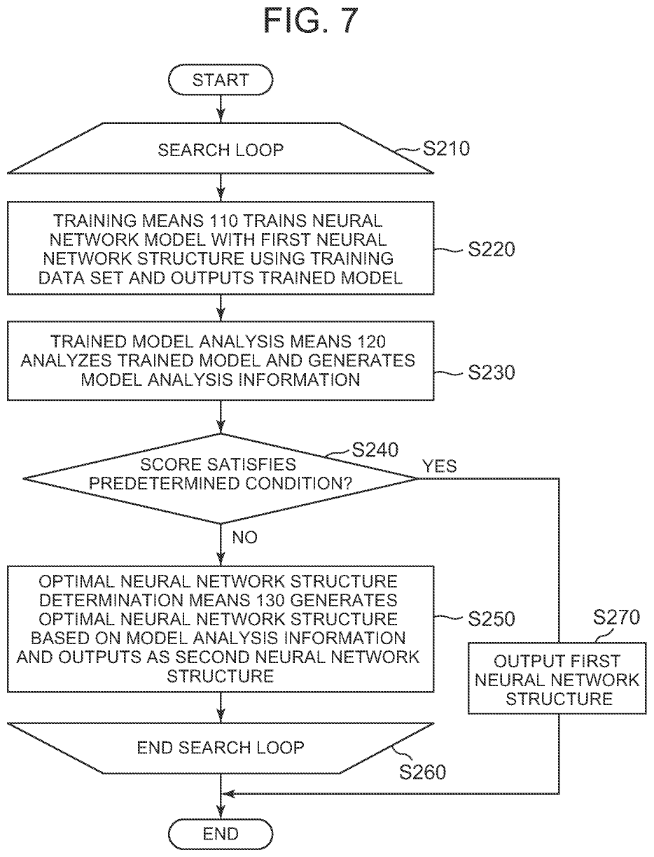

Hereinafter, the operation of the neural network structure search device 100 of this example embodiment will be described with reference to FIGS. 6-7. FIG. 6 is a flowchart showing an operation of the neural network structure searching process by the neural network structure search device 100 of the present example embodiment.

First, a first neural network structure and a training data set are input to the neural network structure search device 100.

The training means 110 trains the neural network model with the input first neural network structure using the input training data set and outputs the trained model, which is the result of the training (step S110). The training means 110 inputs the trained model to the trained model analysis means 120.

Next, the trained model analysis means 120 analyzes the trained model input from the training means 110 and generates model analysis information (step S120). The trained model analysis means 120 inputs the generated model analysis information to the optimal neural network structure determination means 130.

Next, the optimal neural network structure determination means 130 identifies redundant structures in the first neural network structure based on the input model analysis information. The optimal neural network structure determination means 130 then generates an optimal neural network structure by deleting the identified redundant structures from the first neural network structure.

Next, the optimal neural network structure determination means 130 outputs the generated optimal neural network structure as the second neural network structure (step S130). After outputting the second neural network structure, the neural network structure search device 100 terminates the neural network structure searching process.

FIG. 7 is a flowchart showing another operation of the neural network structure searching process by the neural network structure search device 100 of the present example embodiment. FIG. 7 shows an example of when the neural network structure search device 100 repeatedly performs the searching process.

First, the first neural network structure and the training data set are input to the neural network structure search device 100. In other words, it enters a search loop (step S210).

Each process of steps S220-S230 is the same as each process of steps S110-S120 shown in FIG. 6, respectively.

Next, the trained model analysis means 120 determines whether the scores indicated by the model analysis information generated in step S230 satisfy the predetermined condition (step S240). The predetermined condition is, for example, that all scores exceed a specified threshold value.

If the scores satisfy the predetermined condition (Yes in step S240), the trained model analysis means 120 outputs the first neural network structure (step S270). After outputting the first neural network structure, the neural network structure search device 100 terminates the neural network structure searching process.

If the scores do not satisfy the predetermined condition (No in step S240), the optimal neural network structure determination means 130 performs the same process as in step S130 (step S250).

The process of steps S220-S240 is then performed repeatedly. In the second and subsequent processes, the training means 110 receives the second neural network structure generated in step S250 as the first neural network structure.

Even if the scores do not satisfy the predetermined condition, for example, when the process of steps S220 to S250 is performed repeatedly a predetermined number of times, the neural network structure search device 100 exits the search loop (step S260). After exiting the search loop, the neural network structure search device 100 terminates the neural network structure searching process.

### DESCRIPTION OF EFFECT

In the neural network structure search device 100 of this example embodiment, the training means 110 performs training on the entire neural network model with the neural network structure based on the given training data set. Next, the trained model analysis means 120 analyzes the training results by the training means 110. Next, the optimal neural network structure determination means 130 determines the neural network structure such that the recognition accuracy is maintained while the size is reduced.

The neural network structure search device 100 of this example embodiment can reduce the number of training required for neural network structure search. The reason for this is that after the training means 110 first performs training on the entire neural network structure, the trained model analysis means 120 analyzes the trained model, which is the result of training, and the optimal neural network structure determination means 130 determines the optimal structure of the neural network.

The techniques described in NPLs 1-3 have the problem that a large number of training is required to search for neural network structures. The reason for this is that, as mentioned above, training is required to evaluate recognition accuracy.

The neural network structure search device 100 of this example embodiment can determine the optimal neural network structure based on a given training data set without repeating training many times. Specifically, the neural network structure search device 100, in principle, performs training only once for the first time on a neural network model with a neural network structure that is expected to have high accuracy.

The neural network structure search device 100 then accurately identifies redundant portions of the first neural network structure by analyzing the model obtained in training using the training data set. Thus, the neural network structure search device 100 can efficiently determine the optimal neural network structure.

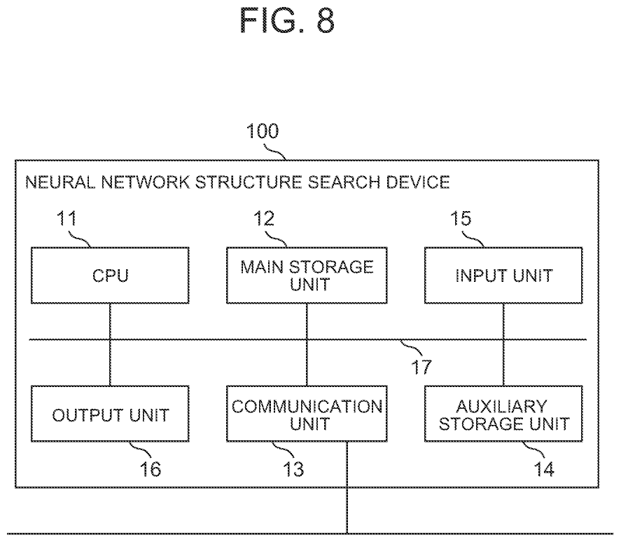

A specific example of a hardware configuration of the neural network structure search device 100 according to this example embodiment will be described below. FIG. 8 is an explanatory diagram showing an example of a hardware configuration of a neural network structure search device according to the present invention.

The neural network structure search device 100 shown in FIG. 8 includes a CPU (Central Processing Unit) 11, a main storage unit 12, a communication unit 13, and an auxiliary storage unit 14. The neural network structure search device 100 also includes an input unit 15 for the user to operate and an output unit 16 for presenting a processing result or a progress of the processing contents to the user.

The neural network structure search device 100 is realized by software, with the CPU 11 shown in FIG. 8 executing a program that provides a function that each component has.

Specifically, each function is realized by software as the CPU 11 loads the program stored in the auxiliary storage unit 14 into the main storage unit 12 and executes it to control the operation of the neural network structure search device 100.

The neural network structure search device 100 shown in FIG. 8 may include a DSP (Digital Signal Processor) instead of the CPU 11. Alternatively, the neural network structure search device 100 shown in FIG. 8 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function to output data. The output unit 16 is, for example, a display device such as a liquid crystal display device, or a printing device such as a printer.

As shown in FIG. 8, in the neural network structure search device 100, each component is connected to the system bus 17.

The auxiliary storage unit 14 stores programs for realizing the training means 110, the trained model analysis means 120 and the optimal neural network structure determination means 130 in the neural network structure search device 100.

The neural network structure search device 100 may be implemented with a circuit that contains hardware components inside such as an LSI (Large Scale Integration) that realize the functions shown in FIG. 1, for example.

The neural network structure search device 100 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

Some or all of each component of the neural network structure search device 100 may be configured by one or more information processing devices which include a computation unit and a storage unit.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

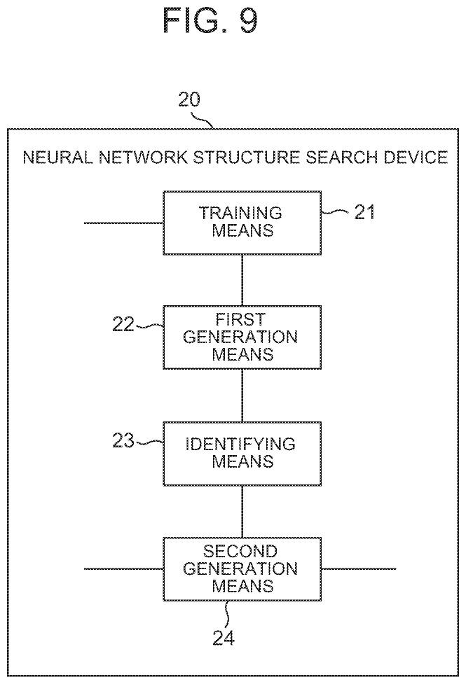

Next, an overview of the present invention will be explained. FIG. 9 is a block diagram showing an overview of a neural network structure search device according to the present invention. The neural network structure search device 20 according to the present invention is a neural network structure search device includes a training means 21 (for example, the training means 110) which trains a neural network model with a first neural network structure using a data set for training, a first generation means 22 (for example, the trained model analysis means 120) which generates analysis information indicating an importance of each of elements comprising the first neural network structure by analyzing a trained model generated from the neural network model by the training using the data set for training, an identifying means 23 (for example, the optimal neural network structure determination means 130) which identifies an element in the first neural network structure whose importance is lower than a predetermined value using the generated analysis information, and a second generation means 24 (for example, the optimal neural network structure determination means 130) which generates a second neural network structure based on the first neural network structure by deleting the identified element from the first neural network structure.

With such a configuration, the neural network structure search device can reduce the number of training times required for searching a neural network structure.

Each element may also include a layer that constitutes the first neural network structure. The second generation means 24 may also determine an element to be deleted among the identified elements using a processing time of an arithmetic unit in the layer. The second generation means 24 may also determine an element to be deleted among the identified elements using an execution efficiency of an arithmetic unit in the layer.

With such a configuration, the neural network structure search device can generate the second neural network structure based on a processing content in a layer that constitutes the first neural network structure.

Each element may also include weights in a kernel used in a convolution layer that constitutes the first neural network structure, and the second generation means 24 may also remove the kernel that include more than a predetermined percentage of the identified weights.

With such a configuration, the neural network structure search device can meet the CNN.

The first generation means 22 may also compute the importance based on an activation rate obtained by inputting data in the data set for training into the trained model.

With such a configuration, the neural network structure search device can reduce the number of training times required for searching a neural network structure using the activation map.

While the present invention has been explained with reference to the example embodiments and examples, the present invention is not limited to the aforementioned example embodiments and examples. Various changes understandable to those skilled in the art within the scope of the present invention can be made to the structures and details of the present invention.

### INDUSTRIAL APPLICABILITY

The present invention is suitably applied to applications that optimize the neural network structure applied to cameras to speed up the recognition processing while maintaining the accuracy of each of the cameras installed in various locations.

### REFERENCE SIGNS LIST

11 CPU
12 Main storage unit
13 Communication unit
14 Auxiliary storage unit
15 Input unit
16 Output unit
17 System bus
20, 100 Neural network structure search device
21, 110 Training means
22 First generation means
23 Identifying means
24 Second generation means
120 Trained model analysis means
130 Optimal neural network structure determination means

What is claimed is:

1. A neural network structure search device comprising:
a memory configured to store instructions; and
a processor configured to execute the instructions to:
train a neural network model with a first neural network structure using a data set for training;
generate analysis information indicating an importance of each of elements comprising the first neural network structure by analyzing a trained model generated from the neural network model by the training using the data set for training;
identify an element in the first neural network structure whose importance is lower than a predetermined value using the generated analysis information; and
generate a second neural network structure based on the first neural network structure by deleting the identified element from the first neural network structure.

2. The neural network structure search device according to claim 1, wherein each element includes a layer that constitutes the first neural network structure.

3. The neural network structure search device according to claim 2, wherein the processor is further configured to execute the instructions to:
determine an element to be deleted among the identified elements using a processing time of an arithmetic unit in the layer.

4. The neural network structure search device according to claim 2, wherein the processor is further configured to execute the instructions to:
determine an element to be deleted among the identified elements using an execution efficiency of an arithmetic unit in the layer.

5. The neural network structure search device according to claim 1, wherein
each element includes weights in a kernel used in a convolution layer that constitutes the first neural network structure, and
the processor is further configured to execute the instructions to:
remove the kernel that include more than a predetermined percentage of the identified weights.

6. The neural network structure search device according to claim 1, wherein the processor is further configured to execute the instructions to:
compute the importance based on an activation rate obtained by inputting data in the data set for training into the trained model.

7. A neural network structure search method comprising:
training a neural network model with a first neural network structure using a data set for training;
generating analysis information indicating an importance of each of elements comprising the first neural network structure by analyzing a trained model generated from the neural network model by the training using the data set for training;
identifying an element in the first neural network structure whose importance is lower than a predetermined value using the generated analysis information; and
generating a second neural network structure based on the first neural network structure by deleting the identified element from the first neural network structure.

8. The neural network structure search method according to claim 7, wherein each element includes a layer that constitutes the first neural network structure.

9. A computer-readable recording medium recording a neural network structure search program causing a computer to execute:
training a neural network model with a first neural network structure using a data set for training;
generating analysis information indicating an importance of each of elements comprising the first neural network structure by analyzing a trained model generated from the neural network model by the training using the data set for training;
identifying an element in the first neural network structure whose importance is lower than a predetermined value using the generated analysis information; and
generating a second neural network structure based on the first neural network structure by deleting the identified element from the first neural network structure.

10. The recording medium according to claim 9, wherein each element includes a layer that constitutes the first neural network structure.
